(19) United States
(12) Patent Application Publication
(10) Pub. No.: US 2006/0254354 A1
(43) Pub. Date: Nov. 16, 2006

(54) Device for coupling and airplane wheel in rotation with a tachometer

(75) Inventor: Bertrand Maes, Issy Les Moulineaux (FR)

Correspondence Address: YOUNG & THOMPSON, 745 SOUTH 23RD STREET, 2ND FLOOR, ARLINGTON, VA, 22202, US

(73) Assignee: MESSIER-BUGATTI, VELIZY VILLACOUBLAY (FR)

(21) Appl. No.: 11/429,253

(22) Filed: May 8, 2006

(30) Foreign Application Priority Data
May 13, 2005 (FR) 05 04864

(51) Int. Cl. G01P 3/00; B64C 25/00

(52) U.S. Cl. 73/514.39; 244/103 R

(57) ABSTRACT

The device for coupling a tachometer and an airplane wheel includes an elastically deformable sleeve defining, at each of its axial ends, a drive recess suitable for co-operating with a complementary endpiece fitted in the recess.

The present invention relates to a device for coupling and airplane wheel with a tachometer.

### BACKGROUND OF THE INVENTION

Nowadays, modern airplanes are fitted with devices for determining the speed of rotation of their wheels, during landing, takeoff, and taxiing on the ground.

Such a device comprises a tachometer integrated in the wheel spindle supported by the landing gear and around which the wheel is rotatably mounted.

The tachometer is connected to the wheel via a coupling device enabling the shaft of the tachometer to be constrained to rotate with a cap carried by the rim of the wheel, about the axis thereof. The cap is constrained to rotate with the wheel.

Given assembly tolerances and the wear suffered by mechanical parts, it is appropriate for the coupling device to be capable of accommodating any radial offset that might exist between the axis of rotation of the tachometer and the axis of rotation, of the wheel cap. Similarly, the device must be capable of accommodating any axial offset between those two elements. Furthermore, it must be capable of absorbing vibration due to rotation, while withstanding the very severe stresses, particularly in terms of temperature and ability to withstand chemical and mechanical attack, that occur in this particularly highly stressed region of an airplane.

Present mechanical coupling devices provided on airplanes are made up of mechanical parts that move relative to one another, and in particular tripod joints of structure that is relatively complex and of cost that is thus high.

### OBJECTS AND SUMMARY OF THE INVENTION

An object of the invention is to provide both a coupling device and an airplane landing gear element that are of reduced cost.

To this end, the invention provides a device for coupling a tachometer and an airplane wheel in rotation, the device comprising an elastically deformable sleeve defining at each axial end a drive recess suitable for co-operating with a complementary endpiece fitted in the recess.

In particular embodiments, the coupling device includes one or more of the following characteristics:

the drive recesses are identical in section and are defined by a common bore passing right through the sleeve;

the section of at least one drive cavity comprises a plurality of lobes regularly distributed angularly about the axis of the sleeve;

the or each recess comprises three lobes that are regularly spaced apart angularly;

each lobe is defined laterally by two flanks bulging towards the inside of the duct, and interconnected by an end wall;

the hardness of the material constituting the sleeve lies in the range 65 to 85 on the Shore A scale, and is advantageously substantially equal to 75;

the tensile strength of the material constituting the sleeve lies in the range 3200 pounds per square inch (psi) to 4000 psi;

the elongation of the material constituting the sleeve lies in the range 200% to 300%; and

it is made of a hydrogenated nitrile butadiene rubber.

The invention also provides a landing gear element comprising a wheel spindle and a wheel rim mounted to rotate about the spindle, a tachometer engaged in the wheel spindle, and a rotary coupling device as defined above, the tachometer having an endpiece engaged in a recess of the sleeve and the rim being secured to another endpiece engaged in the other recess of the sleeve.

### BRIEF DESCRIPTION OF THE DRAWINGS

The invention can be better understood on reading the following description given purely by way of example and made with reference to the drawings, in which:

FIG. 1 is a diagrammatic longitudinal section view of a landing gear element including a coupling device of the invention;

FIG. 2 is a perspective view of the sleeve of the coupling device of the invention;

FIGS. 3 and 4 are a longitudinal view and a cross-section view respectively of the FIG. 2 sleeve; and

FIGS. 5 and 6 are section views of the tachometer shaft and of the drive endpiece provided on the cap.

### MORE DETAILED DESCRIPTION

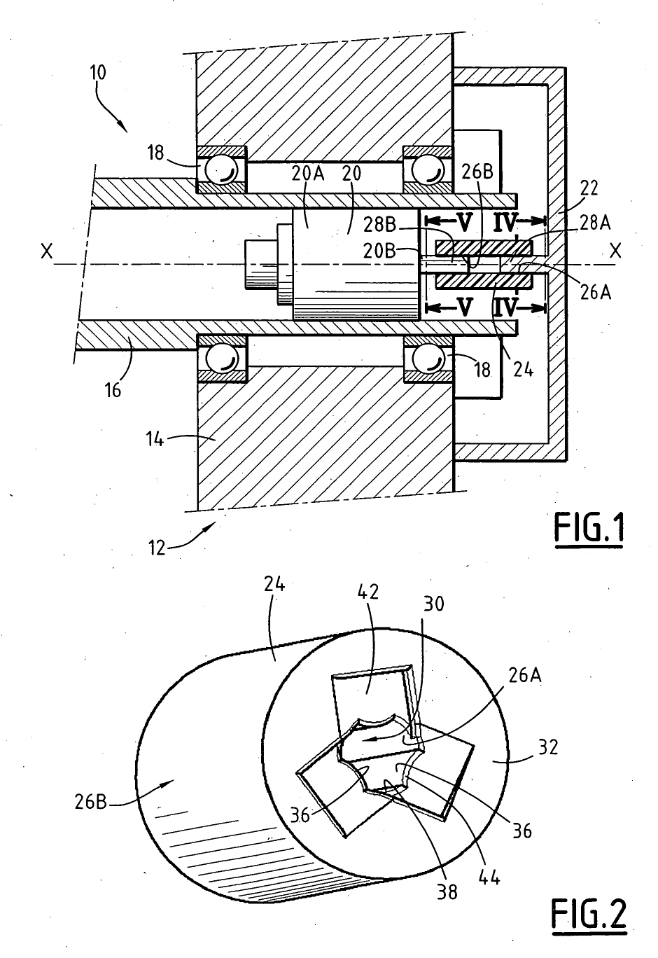

FIG. 1 is a diagram showing a landing gear element 10. It comprises a wheel 12 with only a portion of its rim 14 being shown, together with a hub 16 secured to the landing gear and around which the rim 14 is mounted to rotate about an axis X-X by means of two ball bearings 18. In conventional manner, a tachometer 20 is included inside the wheel spindle 16 for measuring the speed-of rotation of the wheel.

The rim 14 is fitted with an axial cap 22 overlying the tachometer and constrained to rotate with the wheel.

By way of example, the tachometer is constituted by a body 20A secured to the hub 16 and a rotary shaft 20B mounted to rotate substantially about the axis X-X, which shaft 20B drives a rotor, e.g. constituted by an optical encoder or a magnet whose position is determined in order to calculate the speed of rotation of the wheel, in conventional manner.

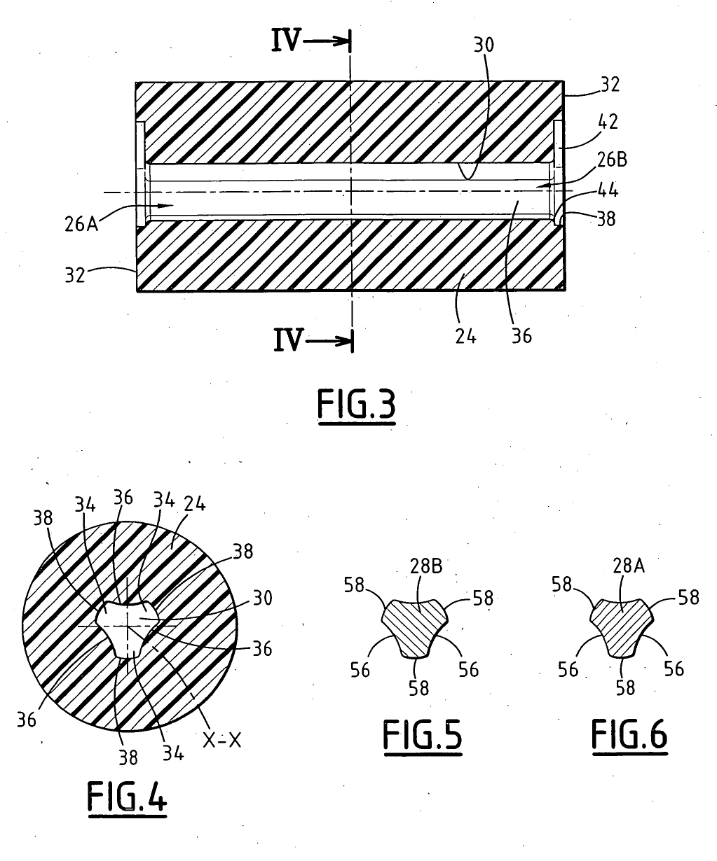

A rotary coupling device 24 is disposed between the cap 22 and the shaft 20B. This device is shown on its own in FIGS. 2 to 4. It comprises, and is advantageously constituted by, an elastically deformable sleeve defining at each of its axial ends a respective drive cavity 26A, 26B, each of which receives a respective driving endpiece 28A, 28B of complementary profile, the endpiece 28A being constrained to rotate with the cap 22 substantially on the axis of rotation X-X, while the endpiece 28B is formed at the end of the shaft 20B of the tachometer. The rotary connection is provided solely by the profiles of complementary section of the cavities and of the endpieces, and no other holding means are provided.

The outside of the sleeve 24 is circularly cylindrical.

Advantageously, the profiles in section of the cavities are identical such that the cavities 26A and 26B defined in the sleeve 24 are defined by end segments of a common bore 30 of constant section passing right through the sleeve 24 and opening out in opposite end surfaces 32 thereof, which surfaces extend parallel to each other and perpendicularly to the axis X-X of the bore 30.

The sections of the endpieces 28A and 28B are shown respectively in FIGS. 5 and 6.

The endpieces 28A and 28B are preferably engaged in the sleeve over lengths lying in the range one-fourth to two-fifths of the length of the sleeve. The insertion length is preferably of the order of one-third of the length of the sleeve, for each endpiece.

Advantageously, the length of the sleeve is about 35 millimeters (mm) (=1.378 inches (″)) for a diameter of about 18 mm (=0.709″).

Depending on the region concerned, the radius of the bore lies in the range 5.5 mm (=0.217″) and 2 mm (=0.079″).

In section, the duct 30 presents a plurality of lobes 34 that are regularly distributed angularly about the axis X-X. These lobes are advantageously three in number. They are defined by three curved flanks 36 that bulge towards the inside of the duct 30, of constant section and connected to one another via generally concave end walls 38.

In section, the bulging flanks 36 present a radius of curvature that is substantially constant over their entire angular extent.

Each end wall 38 extends angularly over a segment lying in the range 20° to 40°, e.g. equal to about 30°. At their ends connected to the end wall 38, the opposite bulging flanks 36 of a given lobe present tangents that define between them an angle lying in the range 20° to 40°, e.g. equal to about 30°.

At the open ends of the bore 30, each of the end walls 32 of the sleeve present radial notches 42 each extending from the middle portions of the end walls 38 where they meet. Thus, the notches 42 have the same axes of symmetry as the flanks 36 and each is diametrically opposite a respective lobe 34. The notches are to make it easier to engage the sleeve on the axis of the tachometer.

The sleeve is preferably made of a single block of plastics material. The material is preferably constituted by a rubber of the hydrogenated nitrile butadiene rubber (HNBR) family, having properties that are compatible with airplane wheel environments in terms of temperatures and fluids.

The hardness of the material constituting the sleeve on the Shore A scale (American Society for Testing and Materials (ASTM) D2240) preferably lies in the range 65 to 85, and is advantageously substantially equal to 75. The tensile strength at break (ASTM D1414) preferably lies in the range 3200 psi to 4000 psi. It is advantageously about 3680 psi.

The elongation of the material constituting the sleeve (ASTM D1414) lies in the range 200% to 300%, it is advantageously about 244%.

At each end, the bore 30 presents generally rounded connecting fillets 44 between the surfaces extending along the axis X-X and the transverse end surfaces 32 of the sleeve, so as to form a profile converging towards the inside of the bore, enabling the endpieces 28A and 28B to be guided during assembly.

The endpieces 28A and 28B present sections that are exactly complementary to the section of the bore 30. Thus, in section, each endpiece presents three arms that are angularly spaced apart at 120° intervals, these arms being defined by curved flanks 56 interconnected by bulging end walls 58.

It can be understood that engaging the endpieces 28A and 28B in the bore 30 of the sleeve enables the shaft 20B to be driven in rotation by rotation of the cap 22 secured to the wheel rim.

In addition, since the sleeve is selected to be sufficiently deformable, it serves to accommodate the radial and axial displacements of the cap relative to the shaft 20B, these displacements being the result of the manufacturing tolerances and of the wear of the various elements.

Since the sleeve is injected as a single block, it can be made at low cost.

What is claimed is:

1. A device for coupling a tachometer and an airplane wheel in rotation, the device comprising an elastically deformable sleeve defining at each axial end a drive recess suitable for co-operating with a complementary endpiece fitted in the recess.

2. A coupling device according to claim 1, wherein the drive recesses are identical in section and are defined by a common bore passing right through the sleeve.

3. A coupling device according to claim 1, wherein the section of at least one drive cavity comprises a plurality of lobes regularly distributed angularly about the axis of the sleeve.

4. A coupling device according to claim 3, wherein the or each recess comprises three lobes that are regularly spaced apart angularly.

5. A coupling device according to claim 3, wherein each lobe is defined laterally by two flanks bulging towards the inside of the duct, and interconnected by an end wall.

6. A coupling device according to claim 1, wherein the hardness of the material constituting the sleeve lies in the range 65 to 85 on the Shore A scale, and is advantageously substantially equal to 75.

7. A coupling device according to claim 1, wherein the tensile strength of the material constituting the sleeve lies in the range 3200 psi to 4000 psi.

8. A coupling device according to claim 1, wherein the elongation of the material constituting the sleeve lies in the range 200% to 300%.

9. A coupling device according to claim 1, the device being made of a hydrogenated nitrile butadiene rubber.

10. A landing gear element comprising a wheel spindle and a wheel rim mounted to rotate about the spindle, a tachometer engaged in the wheel spindle, and a rotary coupling device according to claim 1, the tachometer having an endpiece engaged in a recess of the sleeve and the rim being secured to another endpiece engaged in the other recess of the sleeve.
